(19) United States
(12) Patent Application Publication
(10) Pub. No.: US 2020/0000064 A1
(43) Pub. Date: Jan. 2, 2020

(54) NOTCHED BANDANA TO ACCOMMODATE PET COLLARS AND REVEAL PET TAGS

(71) Applicant: SHARON G. ORTIZ, Albuquerque, NM (US)

(72) Inventor: SHARON G. ORTIZ, Albuquerque, NM (US)

(21) Appl. No.: 16/454,058

(22) Filed: Jun. 27, 2019

Related U.S. Application Data
(60) Provisional application No. 62/692,342, filed on Jun. 29, 2018.

(51) Int. Cl. A01K 27/00

(52) U.S. Cl. CPC A01K 27/001; A01K 13/00; A01K 27/006; A01K 27/005

(57) ABSTRACT

A decorative pet bandana including a collar retaining portion that has a notch formed near the center of the collar retaining portion to reveal pet tags over and near the center of the decorative pet bandana and including two open ends disposed at each ends of the collar retaining portion to reveal pet collar end connectors.

### INVENTION PRIORITY

The present invention claims priority as a to provisional patent application Ser. No. 62/692,342, which was filed Jun. 29, 2018, entitled “NOTCHED BANDANA TO ACCOMMODATE PET COLLARS AND REVEAL PET TAGS”, and is herein incorporated by reference in its entirety for its teachings.

### TECHNICAL FIELD OF THE INVENTION

The present invention is generally related to decorative bandanas and, more particularly, pet bandanas that can accommodate the holding of pet collars within a collar-retaining portion. The present invention is also related to pet bandanas including a notch near the center of the collar-retaining portion where from pet tags affixed to a pet collar can be revealed over a front decorative portion of the bandana and over a pets chest.

### BACKGROUND

Decorative pet bandanas have become popular with pet owners. Typical bandanas (not pet specific, but also usable by humans) were first used on pets by tying them around a pet's neck. Eventually, pet bandanas that included a pet collar retaining portion wherein a pet collar could be feed through a tubular material section of material defining the pet collar retaining portion were provided to the consumer. During use, a pet collar is feed into the collar retaining portion (at either opening end of the collar retaining portion) and pulled through the inner tubular area formed by material comprising the collar retaining portion until both end of the collar and its respective attaching hardware (e.g., buckles, hasps, etc.) are revealed outside of the openings at both ends of the collar retaining portion so that the pet collar, and attached bandana, can be placed around a pet's neck and fastened at the attaching hardware integrated with the pet collar. Pet bandanas can be worn with the large decorative portion typically appearing in a V-shape and placed in front of a pet's chest (like an ascot) or laying on a pets back to reveal a decorative pattern or message to pet owners and other humans.

The problem with current pet bandanas, especially when the owners' desire is for it to be worn in front of their pet's chest, is that pet tags are typically attached to a ring coupled at one end of the pet collar near one of the attaching hardware pieces. Often, several tags are attached to a collar (e.g., tags for pet name/address, current veterinary vaccination, registration/license). The weight caused by tags and the attaching hardware often cause the bandana to gradually rotate around (or move to the left or right) away from a pet's neck and chest area and will often appear crooked while placed on and worn by the pet. Pet owners must continually straighten out the pet bandana because of this rotation that is occurring around their pet's neck that is caused by weight of the tags and attaching hardware.

What is needed is an improved pet bandana design that minimizes the pet bandana's rotation or movement around a pet's neck and enables the main, decorative portion of decorative bandanas and any pet tags associated with a pet collar retained therein to be revealed substantially at the front of a pet's chest.

### SUMMARY OF EMBODIMENTS

It is a feature of the embodiments to provide an improved pet bandana design that minimizes the pet bandana's rotation or movement around a pet's neck and enables the main, decorative portion of decorative bandana and any pet tags associated with a pet collar retained within a collar retaining portion of the bandana to be revealed substantially at the front of a pet's chest.

In accordance with an aspect of the embodiments, a decorative pet bandana can be provided that includes a collar retaining portion having a notch formed near the center of the collar retaining portion to reveal pet tags over and near the center of a decorative surface/side of the decorative pet bandana that is attached to the collar retaining portion, the collar retaining portion including two open ends disposed at each of its ends to reveal at least one of a strap associated with the pet collar and end connectors.

In accordance with another aspect of the embodiments, a decorative pet bandana includes a collar retaining portion having a notch formed near the center of the collar retaining portion to reveal pet tags over and near the center of a decorative surface/side of the decorative pet bandana that is attached to the collar retaining portion, with two open ends disposed at each ends of the collar retaining portion to reveal a pet collar and/or end connectors, and can enable two ends of a pet collar via the pet collar end connectors to be feed into the collar retaining portion from the notch into each side of collar retaining portion disposed opposite each other from the notch until one or both of the collar end connectors are revealed outside the ends of the collar retaining portion.

In accordance with yet another aspect of the embodiments, a decorative pet bandana can be placed around a pet's neck in a manner where a front side of the decorative bandana sits under the pet's head and near the pet's neck and faces away from the pet, and wherein the pet tags are disposed over and substantially centered on the front side of the decorative bandana.

In accordance with yet another aspect of the embodiments, a decorative pet bandana can be provided that includes a collar retaining portion and having a notch formed near the center of the collar retaining portion to reveal pet tags over and near the center of a decorative surface/side of the decorative pet bandana and including two open ends disposed at each ends of the collar retaining portion, and enabling a tag less end of a pet collar via its pet collar end connector to be feed into and the collar retaining portion from the notch into the collar retaining portion and through a first end of the collar retaining portion, then the tagless end is then feed into a second end of the collar retaining portion, opposite the first end and passed through the collar retaining portion towards the notch where the collar end connectors are revealed and can be attached thereby affixing the decorative pet bandana around pet's neck with a decorative side and pets tags facing away from the pet's chest and the end connection hardware connected to secure the bandana onto the pet.

In accordance with yet another aspect of the embodiments, an optional pocket can be formed in the decorative portion of the bandana. The pocket can be used to hold objects such as additional identification information for the pet, prescription medicine to periodically administer to the pet, a wireless RFID tag to track or find the pet, a beacon to track or find the pet, an RF communications device to track or find the pet, a sensor to detect conditions associated with the pet, a speaker to provide wireless commands to the pet, an LED light to provide illumination for the pet, and other objects.

In accordance with another aspect of the embodiments, an optional pocket formed in the decorative portion of the bandana can be water resistant and its opening can be secured/closed using any closure means including zippers, snaps, Velcro™ (hook and loop), or other fasteners.

In accordance with another aspect of the embodiments, an optional pocket formed in the decorative portion of the bandana can be Also, the opening can be provided at the front- or back-side of the bandana.

In accordance with yet another aspect of the embodiments, an optional pocket formed in the decorative portion of the bandana can include a slot formed on the decorative portion to provide a pass-through from the pocket to outside the pocket in order to accommodate and/or reveal an LED light (or other electronics) outside of the pocket.

### BRIEF SUMMARY OF THE DRAWINGS

FIG. 1 illustrates a front side of a decorative pet bandana includes a collar retaining portion and having a notch formed near the center of the collar retaining portion, in accordance with the embodiments;

FIG. 2 illustrates a back side of a decorative pet bandana includes a collar retaining portion and having a notch formed near the center of the collar retaining portion and open ends at each end of the collar retaining portion, in accordance with the embodiments;

FIG. 3 illustrates a prior art dog collar including two end connectors and a tag retaining ring coupled to one end of the dog collar near one of the two end connectors and adapted for use with a decorative pet bandana, in accordance with the embodiments;

FIG. 4 illustrates a front side (decorative side) of a decorative pet bandana and a prior art dog collar including tags at one end with an opposite end and connector hardware that has been feed through a side of a collar retaining portion of a decorative bandana and revealed outside of an end of the collar retaining portion, in accordance with the embodiments;

FIG. 5 illustrates a back side of the decorative pet bandana shown in FIG. 4, with the end connectors attached together at the notch formed in the collar retaining portion, in accordance with the embodiments;

FIG. 6 illustrated a dog collar including two end connectors and a tag retaining ring coupled to the dog collar near its center and therefore adapted for use with a decorative pet bandana, in accordance with the embodiments;

FIG. 7 illustrates the front side (decorative side) of a decorative pet bandana as shown in FIGS. 1-2 and the dog collar of FIG. 6 installed in (both connector ends feed through) the collar retaining portion of the decorative pet bandana at each side of the notch wherein the end connectors are revealed outside of the collar retaining portion and can be connected together once placed around a pet's neck, in accordance with the embodiments;

FIG. 8 illustrated the back side of the decorative pet bandana including an installed collar as shown in FIG. 7, in accordance with the embodiments;

FIG. 9 illustrates a an alternative decorative pet bandana having a notch that is in the shape of a “U”, rather than a “V”, and also illustrates an optional pocket that can be integrated within the decorative portion of a decorative pet bandana, in accordance with the embodiments;

FIG. 10 illustrates a flow diagram of a method of using a decorative pet bandana, in accordance with the embodiments; and

FIG. 11 illustrates another flow diagram of an alternative method of using a decorative pet bandana, in accordance with the embodiments.

### DETAILED DESCRIPTION

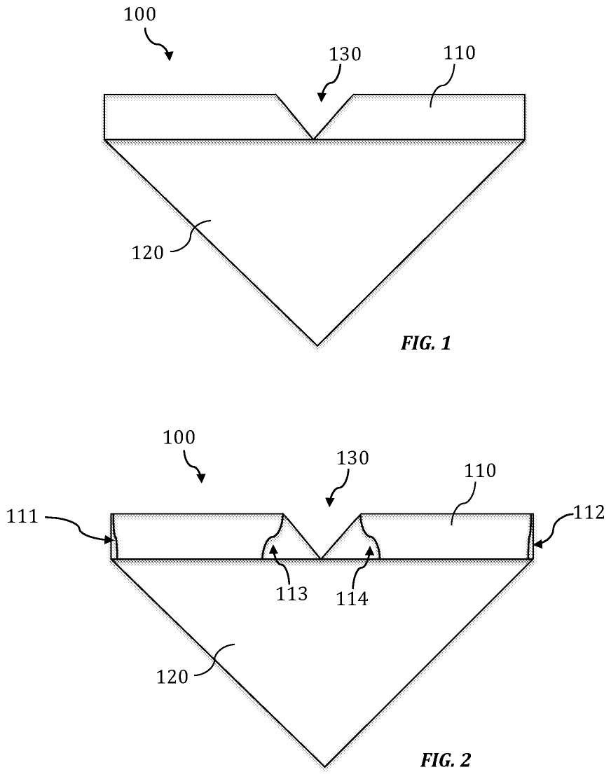

Referring to FIG. 1, illustrated is a decorative pet bandana 100 including a decorative fabric portion 120 and that further includes a collar retaining portion 110 having a notch 130 formed near the center of the collar retaining portion 110, in accordance with the embodiments. The notch 130 is illustrated as a “V”, but other shapes can be appreciated so long as the notch 130 is formed substantially near the center of the collar retaining portion 110.

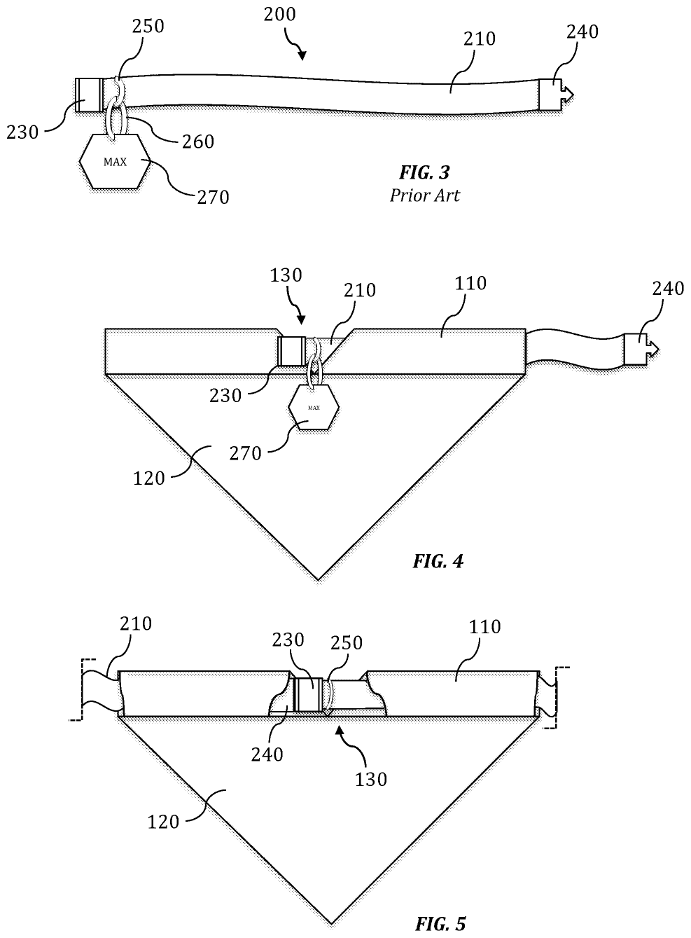

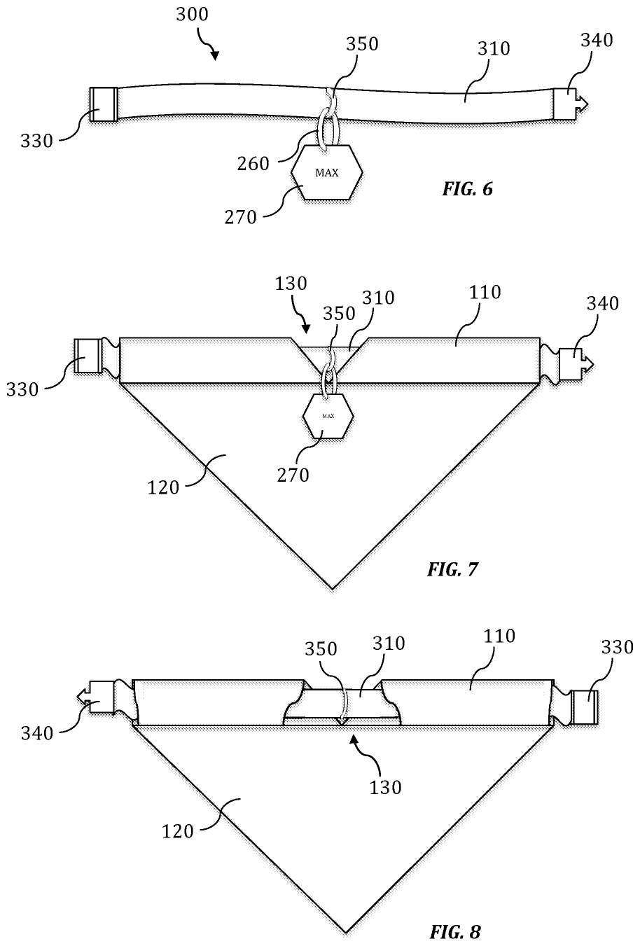

Referring to FIG. 2, illustrates is a back side of a decorative pet bandana 100, including a collar retaining portion 110 and having a notch 130 formed near the center of the collar retaining portion 110. Also illustrated are two open ends 110/112 at each end of the collar retaining portion 110. Near the notch 130 are two inner openings 113/114. When in use with a pet collar, ends of a pet collar (see FIGS. 3 and 6) can be feed through the collar retaining portion 110 at the two open ends 110/112 and the inner openings 113/114, in accordance with the embodiments.

Referring to FIG. 3, illustrated is a “prior art” dog collar 200. Dog collars typically sold to consumers today include two end connectors 230/240 that snap together. One end is typically a “male” connector 240 and is adapted to be inserted into and snapped (held) within a “female” connector 230. A tag retaining ring 250 is commonly coupled at one of the ends 230/240 (typically the female end) and is configured to retain pet tags 270, often using an addition ring 260 associated with the pet tags. This type of dog collar 200 can be used with the decorative pet bandana described herein.

Referring to FIG. 4, illustrates is a front side (decorative side) 120 of the decorative pet bandana 100 and the prior art dog collar 200 including a pet tag 270 coupled near one connector end 230 with an opposite connector end 240 that has been feed through a side of a collar retaining portion 110 of a decorative bandana 100 and is revealed outside of an end of the collar retaining portion 110.

Referring to FIG. 5, illustrated is the back side of the decorative pet bandana 100 shown in FIG. 4, with the end connectors 230/240 now fully attached together at the notch 130 formed in the collar retaining portion 110. When placed around a pet's neck and the end connectors are connected, the decorative fabric portion 120 of the pet bandana 100 and tags 270 being held by the collar 200 can face out (e.g., see FIG. 7) from and remain substantially in front of a pet's chest (not shown).

Referring to FIG. 6, illustrated is a dog collar 300 including two end connectors 330/340 and a tag retaining ring 350 coupled to the dog collar strap 310 near the dog collar's center and therefore ideally adapted for use with the decorative pet bandana 100, in accordance with the embodiments.

Referring to FIG. 7, illustrated is the front side 120 (decorative side) of a decorative pet bandana 100 as shown in FIGS. 1-2 and the dog collar 300 of FIG. 6 installed in (both connector ends 330/340 feed through) the collar retaining portion 110 of the decorative pet bandana 100 at each side of the notch 130, wherein the end connectors 330/340 are revealed outside at each end of the collar retaining portion 110 and can be connected together once placed around a pet's neck, in accordance with the embodiments. Referring to FIG. 8, illustrated is the back side of the decorative pet bandana 100 as shown in FIG. 7 including an installed collar 300, in accordance with the embodiments.

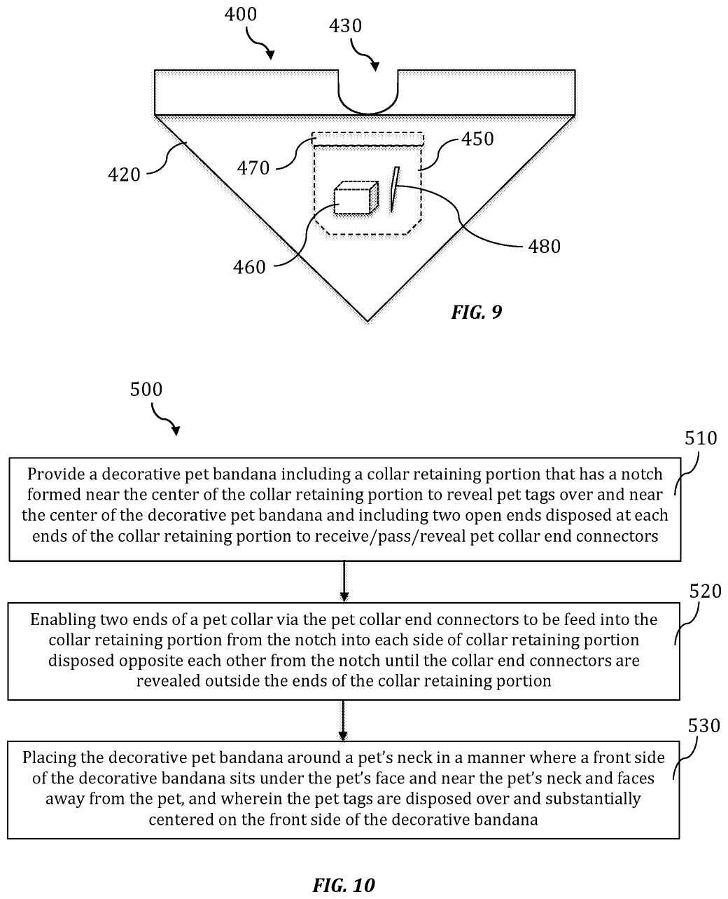

Referring to FIG. 9, illustrates a an alternative decorative pet bandana 400 having a notch 430 that is provided in the shape of a “U”, rather than a “V”. It should be appreciated that the notch can be provided in any shape so long as it is large enough to hold a pet tag portion (and possibly also the connectors) coupled to a pet collar, whether of a prior art design as shown in FIG. 3, or of a newer design as illustrated in FIG. 6. Also illustrated in FIG. 9 is an optional pocket 450 that can be formed in the decorative portion 420 of the bandana. The pocket can be used to hold objects 460 such as additional identification information for the pet, prescription medicine to periodically administer to the pet, a wireless RFID tag to track or find the pet, a beacon to track or find the pet, an RF communications device to track or find the pet, a sensor to detect conditions associated with the pet, a speaker to provide wireless commands to the pet, an LED light to provide illumination for the pet, and other objects. The pocket can be water resistant and its opening 470 can be secured/closed using any closure means including zippers, snaps, Velcro™ (hook and loop), or other fasteners. Also, the opening can be provided at the front- or back-side of the bandana. The bandana can include a slot 480 formed on the decorative portion to provide a pass-through from the pocket to outside the pocket in order to accommodate and/or reveal an LED light (or other electronics) outside of the pocket.

Referring to FIG. 10, illustrated a flow diagram 500 of a method of using a decorative pet bandana, in accordance with the embodiments. Referring to Block 510, a decorative pet bandana can be provided that include a collar retaining portion that has a notch formed near the center of the collar retaining portion to reveal pet tags over and near the center of the decorative pet bandana and including two open ends disposed at each ends of the collar retaining portion to receive/pass/reveal pet collar end connectors. As shown in Block 520, two ends of a pet collar via the pet collar end connectors can be feed into the collar retaining portion from the notch into each side of collar retaining portion disposed opposite each other from the notch until the collar end connectors are revealed outside the ends of the collar retaining portion. Then as shown in Block 530, the decorative pet bandana can be placed around a pet's neck in a manner where a front side of the decorative bandana sits under the pet's face and near the pet's neck and faces away from the pet, and the pet tags can be disposed over and substantially centered on the front side of the decorative bandana.

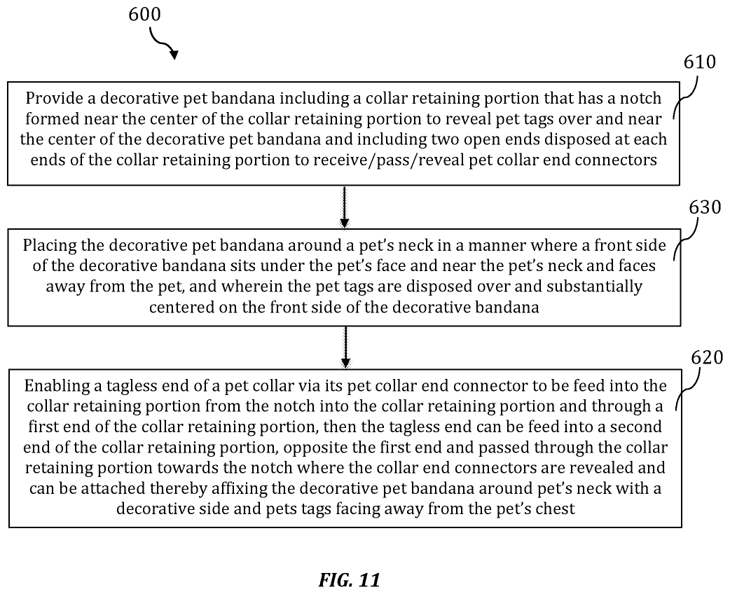

FIG. 11 another flow diagram 600 of an alternative method of using a decorative pet bandana is illustrated, in accordance with the embodiments. Referring to Block 610 a decorative pet bandana can be provided that includes a collar retaining portion that has a notch formed near the center of the collar retaining portion to reveal pet tags over and near the center of the decorative pet bandana and including two open ends disposed at each ends of the collar retaining portion to receive/pass/reveal pet collar end connectors. The decorative pet bandana can be placed around a pet's neck in a manner where a front side of the decorative bandana sits under the pet's face and near the pet's neck and faces away from the pet, and wherein the pet tags are disposed over and substantially centered on the front side of the decorative bandana, as shown in Block 620. Then as shown in Block 630, a tagless end of a pet collar via its pet collar end connector can be feed into the collar retaining portion from the notch into the collar retaining portion and through a first end of the collar retaining portion, then the tagless end can be feed into a second end of the collar retaining portion, opposite the first end and passed through the collar retaining portion towards the notch where the collar end connectors are revealed and can be attached thereby affixing the decorative pet bandana around pet's neck with a decorative side and pets tags facing away from the pet's chest.

1. A decorative pet bandana, comprising:
a decorative portion; and
a collar retaining portion attached to the decorative portion, said collar retaining portion having a notch formed therein near the center of the collar retaining portion to reveal pet tags over and near the center of the decorative pet bandana and including two open ends disposed at each ends of the collar retaining portion to accept pet collar end connectors there through.

2. The decorative pet bandana of claim 1, further comprising a pocket formed in the decorative portion and adapted to contain objects.

3. The decorative pet bandana of claim 2, wherein objects containable in the pocket include at least one of: identification information for the pet, prescription medicine, a wireless RFID tag, a beacon, an RF communications device, a sensor, a speaker, an LED light.

4. The decorative pet bandana of claim 3, wherein a slot is formed on the decorative portion to provide a pass-through from the pocket to outside the pocket to accommodate and reveal an LED light outside of the pocket.

5. The decorative pet bandana of claim 2, wherein the pocket is at least water resistant.

6. The decorative pet bandana of claim 2, wherein an opening of the pocket is closable using at least one of a zipper, snaps, and hook and loop.

7. The decorative pet bandana of claim 2, wherein an opening of the pocket is formed at the front-side of the decorative portion.

8. The decorative pet bandana of claim 2, wherein an opening of the pocket is formed at the back-side of the decorative portion.

9. A decorative pet bandana, comprising:
a decorative portion; and
a collar retaining portion attached to the decorative portion, said collar retaining portion having a notch formed therein near the center of the collar retaining portion to reveal pet tags over and near the center of the decorative pet bandana and including two open ends disposed at each ends of the collar retaining portion to accept pet collar end connectors there through toward two additional opening disposed near the notch and the center of the collar retaining portion.

10. The decorative pet bandana of claim 9, further comprising a pocket formed in the decorative portion and adapted to contain objects.

11. The decorative pet bandana of claim 10, wherein objects containable in the pocket include at least one of: identification information for the pet, prescription medicine, a wireless RFID tag, a beacon, an RF communications device, a sensor, a speaker, an LED light.

12. The decorative pet bandana of claim 10, wherein a slot is formed on the decorative portion to provide a pass-through from the pocket to outside the pocket to accommodate and reveal an LED light outside of the pocket.

13. The decorative pet bandana of claim 10, wherein the pocket is at least water resistant.

14. The decorative pet bandana of claim 10, wherein an opening of the pocket is closable using at least one of a zipper, snaps, and hook and loop.

15. The decorative pet bandana of claim 10, wherein an opening of the pocket is formed at the front-side of the decorative portion.

16. The decorative pet bandana of claim 10, wherein an opening of the pocket is formed at the back-side of the decorative portion.

17. A method, comprising:
providing a decorative pet bandana including a collar retaining portion that has a notch formed near the center of the collar retaining portion to reveal pet tags over and near the center of the decorative pet bandana and including two open ends disposed at each ends of the collar retaining portion to at least one of receive, pass there through, and reveal pet collar end connectors.

18. The method of claim 17, further comprising the steps of:
enabling two ends of a pet collar via the pet collar end connectors to be feed into the collar retaining portion from the notch into each side of collar retaining portion disposed opposite each other from the notch until the collar end connectors are revealed outside the ends of the collar retaining portion; and
placing the decorative pet bandana around a pet's neck in a manner where a front side of the decorative bandana sits under the pet's face and near the pet's neck and faces away from the pet, and wherein the pet tags are disposed over and substantially centered on the front side of the decorative bandana.

19. The method of claim 17, further comprising the steps of:
placing the decorative pet bandana around a pet's neck in a manner where a front side of the decorative bandana sits under the pet's face and near the pet's neck and faces away from the pet, and wherein the pet tags are disposed over and substantially centered on the front side of the decorative bandana; and
enabling a tagless end of a pet collar via its pet collar end connector to be feed into the collar retaining portion from the notch into the collar retaining portion and through a first end of the collar retaining portion, then the tagless end can be feed into a second end of the collar retaining portion, opposite the first end and passed through the collar retaining portion towards the notch where the collar end connectors are revealed and can be attached thereby affixing the decorative pet bandana around pet's neck with a decorative side and pets tags facing away from the pet's chest.

20. The method of claim 17, further comprising forming a pocket in the decorative portion, said pocket and adapted to contain objects.
